(19) United States
(12) Patent Application Publication
(10) Pub. No.: US 2026/0085213 A1
(43) Pub. Date: Mar. 26, 2026

(54) ADHESIVE COMPOSITION, ADHESIVE SHEET, AND DISPLAY INCLUDING THE SAME

(71) Applicant: DONGWOO FINE-CHEM CO., LTD., Iksan-si (KR)

(72) Inventors: Jin-Woo LEE, Iksan-si (KR); In-Oh HWANG, Iksan-si (KR); Kyoung-Moon JUNG, Iksan-si (KR); Hye-Rim KWON, Iksan-si (KR)

(73) Assignee: DONGWOO FINE-CHEM CO., LTD., Iksan-si (KR)

(21) Appl. No.: 19/331,444

(22) Filed: Sep. 17, 2025

(30) Foreign Application Priority Data
Sep. 20, 2024 (KR) 10-2024-0127236
Sep. 16, 2025 (KR) 10-2025-0132417

(51) Int. Cl. C09J 7/38; C09J 11/06

(52) U.S. Cl. CPC C09J 7/385; C09J 11/06; C09J 2203/326; C09J 2301/408; C09J 2301/414

(57) ABSTRACT

Disclosed is an adhesive composition including an acrylic copolymer, a crosslinking agent, an additive, and an UV absorber, wherein the UV absorber includes at least one selected from the group consisting of a compound represented by Formula 1 and a compound represented by Formula 2. The adhesive composition may prevent UV-induced deterioration due to its excellent UV absorption ability, and at the same time, may have excellent folding properties by having high adhesive strength while having low elastic modulus at low temperatures. Also disclosed are an adhesive sheet and display including the adhesive composition.

### CROSS-REFERENCE TO RELATED APPLICATION(S)

This application claims the benefit under 35 USC 119 (a) of Korean Patent Application No. KR 10-2024-0127236, filed on Sep. 20, 2024 and Korean Patent Application No. KR 10-2025-0132417, filed on Sep. 16, 2025, with the Korean Intellectual Property Office, the disclosures of which are incorporated herein by reference in its entirety.

### BACKGROUND

### 1. Technical Field

The present disclosure relates to an adhesive composition, an adhesive sheet, and a display including the same.

### 2. Related Art

In the display industry, optically transparent pressure-sensitive adhesives are widely used to mount touch panels or touch screens or to achieve high brightness and high transmittance.

The adhesive used to attach a transparent film or ultra-thin glass (UTG) to a touch screen or touch panel used in the display industry is required to have not only adhesion to various substrates but also durability so that the occurrence of curls or bubbles even when exposed to harsh conditions such as low temperatures and ultraviolet rays may be suppressed. In particular, in fields requiring precise dimensional stability, such as electronic materials, it is necessary to develop an adhesive composition having excellent durability so as to be capable of preventing the occurrence of curls, bubbles, or peeling under harsh conditions such as low temperatures and ultraviolet rays, as described above.

With the recent advancement of display technology, research and development are underway on display devices that may be deformed during use, such as by folding or rolling. Because these displays may be deformed into various forms, they may satisfy both the demand for increased size during use and the demand for reduced size for portability.

A deformable display device may be deformed into a predetermined shape, as well as into various shapes depending on the user's needs or the needs of the situation in which the display device is used. Therefore, it is necessary to recognize the deformed shape of the display device and control the display device in response to the recognized shape.

Meanwhile, since there is a problem in that each component of a deformable display device may be damaged due to the deformation of the display device, each component of the display device has to satisfy folding reliability and stability, and the adhesive used in the deformable display device also has to satisfy the aforementioned folding reliability and stability.

Korean Patent Application Publication No. 10-2023-0113849 includes an adhesive composition for a display including a UV absorber, but the adhesive composition has limitations in that it cannot ensure excellent durability due to its low folding reliability and stability in a deformable display.

### PRIOR ART DOCUMENTS

### Patent Documents

Korean Patent Application Publication No. 10-2023-0113849

### SUMMARY

The present disclosure is intended to solve the above-described conventional technical problems, and an object of the present disclosure is to provide an adhesive composition that may prevent UV-induced deterioration due to its excellent UV absorption ability, and at the same time, may have excellent folding properties by having high adhesive strength while having low elastic modulus at low temperatures.

Another object of the present disclosure is to provide an adhesive sheet and display manufactured using the adhesive composition.

However, the problems to be solved by the present disclosure are not limited to the problems mentioned above, and other problems not mentioned will be clearly understood by those skilled in the art from the following description.

In order to achieve the above objects, the present disclosure provides an adhesive composition including an acrylic copolymer, a crosslinking agent, an additive, and an UV absorber, wherein the UV absorber includes at least one selected from the group consisting of a compound represented by Formula 1 below and a compound represented by Formula 2 below:

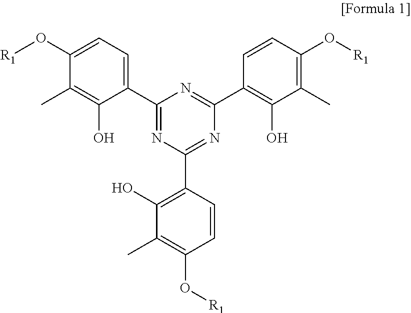

wherein R₁s are each independently a linear or branched alkyl group having 8 or more carbon atoms;

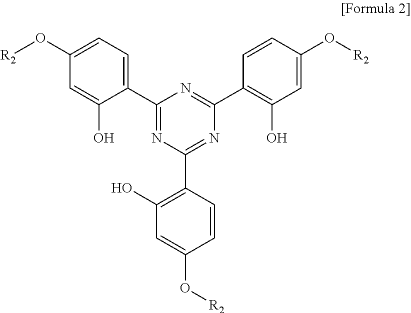

wherein R₂s are each independently a linear or branched alkyl group having 8 or more carbon atoms.

R₁s may be each independently a linear or branched alkyl group having 8 to 24 carbon atoms, and R₂s may be each independently a linear or branched alkyl group having 8 to 24 carbon atoms.

The UV absorber may be included in an amount of 0.1 to 5 parts by weight based on 100 parts by weight of the acrylic copolymer.

The acrylic copolymer may include a linear or branched alkyl (meth)acrylate monomer having 8 to 30 carbon atoms.

The acrylic copolymer may further include a polar group-containing (meth)acrylate monomer and a hydroxyl group-containing (meth)acrylate monomer.

The crosslinking agent may include a metal chelate-based crosslinking agent.

The crosslinking agent may include one selected from the group consisting of zirconium, aluminum, zinc, and magnesium.

The crosslinking agent may further include at least one selected from the group consisting of isocyanate-based, aziridine-based, epoxy-based, melamine-based, peroxide-based, and oxazoline-based crosslinking agents.

The additive may further include at least one selected from the group consisting of a silane coupling agent, an antistatic agent, an antioxidant, an anti-corrosion agent, a leveling agent, a surface lubricant, an antifoaming agent, a filler, a plasticizer, and a reaction initiator.

An adhesive sheet formed from the adhesive composition may have a light transmittance of 10% or less at a wavelength of 380 nm.

The adhesive sheet formed from the adhesive composition may have an elastic modulus of 40 kPa to 100 kPa at −20° C. and 1 Hz.

The present disclosure also provides an adhesive sheet including the adhesive composition.

The present disclosure also provides a display including the adhesive sheet.

The present disclosure may provide an adhesive composition that may prevent UV-induced deterioration due to its excellent UV absorption ability, and at the same time, may have excellent folding properties by having high adhesive strength while having low elastic modulus at low temperatures.

The present disclosure may also provide an adhesive sheet manufactured using the adhesive composition and a display including the adhesive sheet.

### DETAILED DESCRIPTION

The present disclosure relates to an adhesive composition including an acrylic copolymer, a crosslinking agent, an additive, and an UV absorber, wherein the UV absorber includes at least one selected from the group consisting of a compound represented by Formula 1 and a compound represented by Formula 2, and an adhesive sheet and display including the same. In the present disclosure, it has been experimentally confirmed that, when an adhesive composition includes a UV absorber including at least one selected from the group consisting of a compound represented by Formula 1 and a compound represented by Formula 2, it may prevent UV-induced deterioration due to its excellent UV absorption ability, and at the same time, may have excellent folding properties by having high adhesive strength while having low elastic modulus at low temperatures. Based on this fact, the present disclosure has been completed. Specifically, the adhesive sheet formed from the adhesive composition may have a light transmittance of 10% or less at a wavelength of 380 nm based on a thickness of 10 to 150 μm.

Hereinafter, each component of the adhesive composition of the present disclosure will be described in detail. However, the present disclosure is not limited by these components.

### <Adhesive Composition>

The adhesive composition of the present disclosure includes a novel UV absorber having a specific structure, and thus may prevent UV-induced deterioration due to its excellent UV absorption ability, and at the same time, may exhibit excellent folding properties by having high adhesive strength while having low elastic modulus at low temperatures. The adhesive composition may further include an acrylic copolymer, a crosslinking agent, an additive, and/or a solvent.

### Acrylic Copolymer

The acrylic copolymer of the present disclosure may include a linear or branched alkyl (meth)acrylate monomer having 8 to 30 carbon atoms. Preferably, the acrylic copolymer may further include a polar group-containing (meth)acrylate monomer and a hydroxyl group-containing (meth)acrylate monomer. The acrylic copolymer may be produced by dissolving the monomers in a solvent, followed by a thermal polymerization or photopolymerization reaction, without being limited thereto. The solvent is not particularly limited as long as it may dissolve the monomers for producing the acrylic copolymer of the present disclosure. In addition, a thermal polymerization initiator or a photopolymerization initiator may be used for the thermal polymerization or photopolymerization reaction.

### Linear or Branched Alkyl (Meth)Acrylate Monomer Having 8 to 30 Carbon Atoms

The acrylic copolymer of the present disclosure may include a linear or branched alkyl (meth)acrylate monomer having 8 to 30 carbon atoms.

The “(meth)acrylate” refers to both acrylate and methacrylate.

As the linear or branched alkyl (meth)acrylate monomer having 8 to 30 carbon atoms has a number of carbon atoms limited within the above range, it may preferably exhibit low elastic modulus properties at low temperatures due to its low glass transition temperature, thereby exhibiting excellent adhesive strength and folding properties.

Specific examples of the linear or branched alkyl (meth)acrylate having 8 to 30 carbon atoms include 2-ethylhexyl (meth)acrylate, lauryl (meth)acrylate, n-octyl (meth)acrylate, isooctyl (meth)acrylate, n-nonyl (meth)acrylate, isononyl (meth)acrylate, n-decyl (meth)acrylate, isodecyl (meth)acrylate, n-dodecyl (meth)acrylate, n-tridecyl (meth)acrylate, n-tetradecyl (meth)acrylate, 2-decyltetradecyl (meth)acrylate, 2-dodecylhexadecyl (meth)acrylate, stearyl (meth)acrylate, and 2-decyl-1-tetradecanyl (meth)acrylate, which may be used alone or in combination of two or more.

The linear or branched alkyl (meth)acrylate having 8 to 30 carbon atoms is preferably included in an amount of 60 to 91.99 wt % based on the total weight of the monomers used for the production of the acrylic copolymer. When the linear or branched alkyl (meth)acrylate having 8 to 30 carbon atoms is included in an amount within the above range, the glass transition temperature may be lowered, thereby improving the low-temperature elastic modulus, thus providing excellent low-temperature folding properties.

### Polar Group-Containing (Meth)Acrylate Monomer

The acrylic copolymer of the present disclosure may include a polar group-containing (meth)acrylate monomer.

The polar group-containing (meth)acrylate monomer is characterized by having a polar group other than a hydroxyl group, and specific examples thereof include, but are not limited to, monomers containing other functional groups, such as a carboxyl group-containing (meth)acrylate monomer, an amide group-containing (meth)acrylate monomer, an amino group-containing (meth)acrylate monomer, an imide group-containing (meth)acrylate monomer, an epoxy group-containing (meth)acrylate monomer, an ether group-containing (meth)acrylate monomer, and the like.

As the acrylic copolymer includes the polar group-containing (meth)acrylate monomer, it may have an excellent effect of forming an adhesive layer having excellent adhesive strength through crosslinking between the monomers.

Examples of the carboxyl group-containing (meth)acrylate monomer include acrylic acid, methacrylic acid, 2-carboxyethyl acrylic acid, 2-(meth)acryloyloxy acetic acid, 3-(meth)acryloyloxy propylic acid, 4-(meth)acryloyloxy butyric acid, an acrylic acid dimer, itaconic acid, maleic acid, and the like.

Examples of the amino group-containing (meth)acrylate monomer include aminoethyl (meth)acrylate, N,N-dimethylaminoethyl (meth)acrylate, N,N-dimethylaminopropyl (meth)acrylate, (meth)acryloylmorpholine, and the like.

Examples of the above imide group-containing (meth)acrylate monomer include cyclohexylmaleimide, isopropylmaleimide, N-cyclohexylmaleimide, itaconimide, and the like.

Examples of the epoxy group-containing (meth)acrylate monomer include glycidyl (meth)acrylate, methyl glycidyl (meth)acrylate, allyl glycidyl ether, and the like.

Examples of the ether group-containing (meth)acrylate monomer include methoxyethyl (meth)acrylate, ethoxymethyl (meth)acrylate, ethoxyethyl (meth)acrylate, propoxyethyl (meth)acrylate, butoxyethyl (meth)acrylate, methoxypropyl (meth)acrylate, methoxybutyl (meth)acrylate, ethoxy-diethylene glycol (meth)acrylate, methoxy-triethylene glycol (meth)acrylate, 2-ethylhexyl-diglycol (meth)acrylate, methoxy-polyethylene glycol (meth)acrylate, methoxy dipropylene glycol (meth)acrylate, and the like.

The polar group-containing (meth)acrylate monomer is preferably included in an amount of 0.01 to 3 wt % based on the total weight of the monomers used for the production of the acrylic copolymer. When the polar group-containing (meth)acrylate monomer is included in an amount within the above range, it is preferable because the adhesive composition may have high adhesive strength, thereby ensuring excellent durability.

### Hydroxyl Group-Containing (Meth)Acrylate Monomer

The acrylic copolymer of the present disclosure may include a hydroxyl group-containing (meth)acrylate monomer.

As the acrylic copolymer includes the hydroxyl group-containing (meth)acrylate monomer, the acrylic copolymer may have a low glass transition temperature property, so that the adhesive composition may exhibit folding properties.

Specific examples of the hydroxyl group-containing (meth)acrylate monomer include 2-hydroxypropyl (meth)acrylate, 4-hydroxybutyl (meth)acrylate, 6-hydroxyhexyl (meth)acrylate, 8-hydroxyoctyl (meth)acrylate, 2-hydroxyethylene glycol (meth)acrylate, and 2-hydroxypropylene glycol (meth)acrylate, which may be used alone or in combination of two or more.

When the acrylic copolymer include 2-hydroxyethyl (meth)acrylate as the hydroxyl group-containing (meth)acrylate monomer, it is difficult for the acrylic copolymer to exhibit low elastic modulus properties at low temperatures, due to the high glass transition temperature of 2-hydroxyethyl (meth)acrylate. Thus, the acrylic copolymer preferably does not include this monomer.

The hydroxyl group-containing (meth)acrylate monomer is preferably included in an amount of 8 to 30 wt % based on the total weight of the monomers used for the production of the acrylic copolymer. When the above-mentioned hydroxyl group-containing (meth)acrylate monomer is included in an amount within the above range, it is preferable because the content of the hydroxyl group-containing (meth)acrylate monomer, which has high reactivity with the crosslinking agent, may be sufficiently ensured that the monomer may have appropriate cohesiveness, so that the adhesive sheet has excellent folding properties while ensuring durability.

The weight-average molecular weight (Mw) of the acrylic copolymer is 500,000 to 2,000,000, preferably 700,000 to 1,700,000, more preferably 1,000,000 to 1,200,000, in order to ensure low-temperature elastic modulus and folding properties of the adhesive composition including the acrylic copolymer. If the weight-average molecular weight of the acrylic copolymer is lower than the lower limit of the above range, it may be difficult to ensure adhesive properties and durability, and if the weight-average molecular weight is higher than the upper limit of the above range, a problem may arise in that it is difficult to ensure processability.

### Crosslinking Agent

The adhesive composition of the present disclosure may further include a crosslinking agent to enhance the cohesiveness of the adhesive.

The crosslinking agent is not particularly limited as long as it is a component that may enhance the cohesiveness of the adhesive by appropriately crosslinking the acrylic copolymer.

The crosslinking agent may contain, for example, a functional group that reacts with a crosslinkable functional group derived from a crosslinkable group-containing monomer of a (meth)acrylate copolymer, and thus improve the adhesion and durability of the adhesive composition and maintaining high-temperature reliability and the shape of the adhesive.

Examples of the crosslinking agent include a metal chelate-based crosslinking agent, an isocyanate-based crosslinking agent, an epoxy-based crosslinking agent, an oxazoline-based crosslinking agent, an aziridine-based crosslinking agent, and the like. Thereamong, the metal chelate-based crosslinking agent is preferably used in terms of improving the adhesiveness of the adhesive by forming a coordination bond or ionic bond with the surface of an adherend.

Specifically, the metal atom of the metal chelate-based crosslinking agent may form a coordination bond with a polar functional group of the acrylic copolymer, such as a hydroxyl group or a carboxyl group, so that the cohesiveness and mechanical stability of the adhesive may be further improved. In addition, the metal chelate-based crosslinking agent can form a coordination bond or an ionic bond with the surface of an adherend treated with, for example, corona or plasma, so that the adhesive may have improved adhesion.

Examples of the metal chelate-based crosslinking agent include compounds in which a multivalent metal such as zirconium, aluminum, zinc, and/or magnesium is coordinated to acetylacetone or ethyl acetoacetate. These compounds may be used alone or in combination of two or more.

Specific examples of the isocyanate-based crosslinking agent include polyfunctional isocyanate compounds such as toluene diisocyanate, xylene diisocyanate, diphenylmethane diisocyanate, hexamethylene diisocyanate, isophorone diisocyanate, tetramethylxylene diisocyanate, or naphthalene diisocyanate, or compounds obtained by reacting the polyfunctional isocyanate compounds with polyol compounds such as trimethylol propane. These compounds may be used alone or in combination of two or more.

Specific examples of the epoxy-based crosslinking agent include diglycidylaniline, ethylene glycol diglycidyl ether, polyethylene glycol diglycidyl ether, sorbitol polyglycidyl ether, glycerol polyglycidyl ether, pentaerythritol polyglycidyl ether, polyglycerol polyglycidyl ether, trimethylolpropane polyglycidyl ether, adipic acid diglycidyl ester triglycidyl ether, trimethylolpropane triglycidyl ether, N,N,N′,N′-tetraglycidyl-m-xylenediamine, N,N,N′,N′-tetraglycidyl ethylenediamine, glycerin diglycidyl ether, and the like. These may be used alone or in combination of two or more.

Specific examples of the oxazoline-based crosslinking agent include copolymers including at least one monomer containing an oxazoline group, such as 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline, and 2-isopropenyl-5-ethyl-2-oxazoline. These may be used alone or in combination of two or more.

Specific examples of the aziridine-based crosslinking agent include N,N′-toluene-2,4-bis(1-aziridinecarboxamide), N,N′-diphenylmethane-4,4′-bis(1-aziridinecarboxamide), triethylene melamine, bis(isophthaloyl)-1-(2-methylaziridine), and tri-1-aziridinylphosphine oxide. These may be used alone or in combination of two or more.

The crosslinking agent may be included in an amount of 0.1 to 1 part by weight, preferably 0.1 to 0.5 parts by weight, based on 100 parts by weight of the acrylic copolymer. If the content of the crosslinking agent is less than 0.1 parts by weight, there is a problem in that the cohesiveness of the adhesive composition is excessively reduced, resulting in deterioration of durability. If the content of the crosslinking agent is more than 1 part by weight, there is a problem in that an excessive crosslinking reaction progresses, resulting in excessive reduction of adhesive strength.

### Additive

The additive may be optionally added as needed, and may include, for example, at least one selected from the group consisting of silane coupling agents.

The type of above silane coupling agent is not particularly limited, and specific examples of usable silane coupling agents include vinyltrimethoxysilane, vinyltriethoxysilane, vinyltris(2-methoxyethoxy) silane, N-(2-aminoethyl)-3-aminopropylmethyldimethoxysilane, N-(2-aminoethyl)-3-aminopropyltrimethoxysilane, 3-aminopropyltriethoxysilane, 3-glycidoxypropyltrimethoxysilane, 3-glycidoxypropylmethyldimethoxysilane, 2-(3,4-epoxycyclohexyl)ethyltrimethoxysilane, 3-chloropropylmethyldimethoxysilane, 3-chloropropyltrimethoxysilane, 3-methacryloxypropyltrimethoxysilane, 3-mercaptopropyltrimethoxysilane, 3-isocyanatopropyltrimethoxysilane, 3-isocyanatopropyltriethoxysilane, and the like.

In addition, in addition to the silane coupling agent exemplified above, additives known in the art such as an antistatic agent, an antioxidant, an anti-corrosion agent, a leveling agent, a surface lubricant, a defoaming agent, a filler, a plasticizer, and a reaction initiator may be further contained as needed.

The additives exemplified above may be used alone or in combination of two or more. The additive may be included in an amount of 0.05 to 6 parts by weight, preferably 0.5 to 6 parts by weight, based on 100 parts by weight of the acrylic copolymer.

### UV Absorber

The adhesive composition of the present disclosure includes a UV absorber, wherein the UV absorber may include at least one selected from the group consisting of a compound represented by Formula 1 and a compound represented by Formula 2 below:

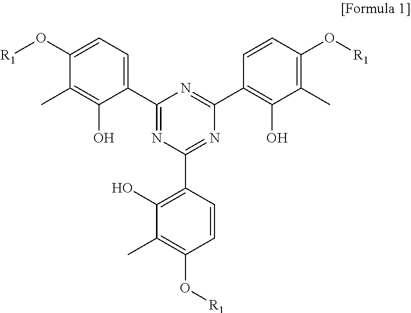

wherein R₁s are each independently a linear or branched alkyl group having 8 or more carbon atoms;

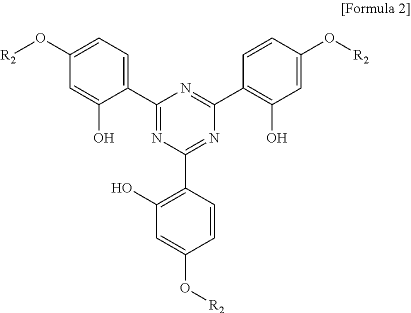

wherein R₂s are each independently a linear or branched alkyl group having 8 or more carbon atoms.

When the UV absorber includes at least one selected from the group consisting of the compound represented by Formula 1 and the compound represented by Formula 2, it is preferable because the UV absorber may have increased solubility in the adhesive composition including the acrylic copolymer having a low glass transition temperature and is not precipitated, so that the adhesive composition has excellent folding properties due to its high adhesive strength.

If R₁ and R₂ in Formulas 1 and 2 above are linear or branched alkyl groups having less than 8 carbon atoms, a problem may arise in that the UV absorber is precipitated. Although there is no particular limitation on the upper limit of the carbon atom number of each of R₁ and R₂ in Formulas 1 and 2 above, if the upper limit of the carbon atom number exceeds a certain value, problems may arise in that synthesis is difficult and the production cost increases. For these reasons, it is preferred that R₁ and R₂ each independently be a linear or branched alkyl group having 8 to 24 carbon atoms, preferably a linear or branched alkyl group having 8 to 18 carbon atoms, more preferably a linear or branched alkyl group having 8 to 16 carbon atoms.

In one embodiment of the present disclosure, the compound represented by Formula 1 may be a compound represented by any one of Formulas 1-1 to 1-2 below.

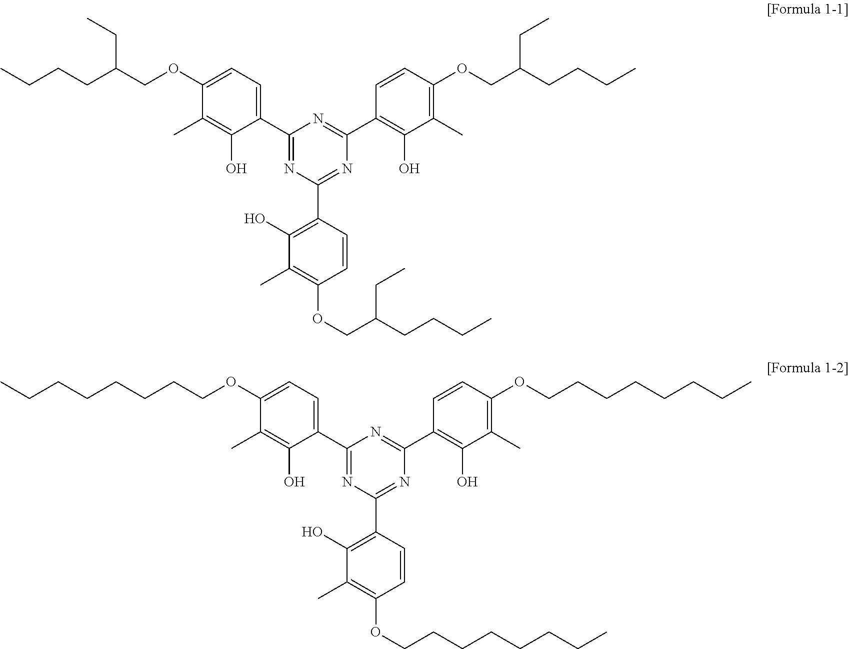

In one embodiment of the present disclosure, the compound represented by Formula 2 may be a compound represented by Formula 2-1 below.

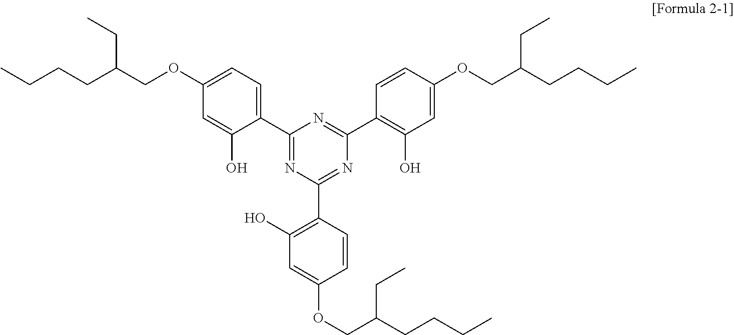 [SMILES: CCCCC(CC)COc1ccc(-c2nc(-c3ccc(OCC(CC)CCCC)cc3O)nc(-c3ccc(OCC(CC)CCCC)cc3O)n2)c(O)c1]

The UV absorber is included in an amount of less than 7 parts by weight, preferably 0.1 to 5 parts by weight, based on 100 parts by weight of the acrylic copolymer, without being limited thereto. When the UV absorber is included in an amount within the above range, there are advantages in that the adhesive composition may sufficiently exhibit the UV absorption function while controlling total light transmittance and haze and having high transparency. Specifically, if the UV absorber is included in an amount of 7 parts by weight or more based on 100 parts by weight of the acrylic copolymer, problems may arise in that the UV absorber is precipitated due to its poor compatibility, causing reduced transparency or reduced adhesive performance such as reduced adhesive strength.

### <Adhesive Sheet>

The present disclosure provides an adhesive sheet manufactured using the above-described adhesive composition. In order to provide the adhesive sheet of the present disclosure, a configuration and manufacturing method commonly used for manufacturing an adhesive layer, an adhesive film, and an adhesive sheet in the art may be used in addition to using the adhesive composition.

The adhesive sheet may have an elastic modulus of 30 kPa to 100 kPa, preferably 40 kPa to 80 kPa, at −20° C. and 1 Hz. By satisfying the elastic modulus as described above, the adhesive sheet may have excellent folding properties, particularly excellent folding properties at low temperatures.

The adhesive sheet may have an adhesive strength of 15 N/25 mm or more, preferably 20 N/25 mm or more, to a substrate, particularly a glass substrate, at room temperature of 23° C. and a relative humidity of 50%. By satisfying the adhesive strength as described above, the adhesive sheet may have excellent folding properties by having high adhesive strength while having low elastic modulus at low temperatures.

In addition, the adhesive sheet has excellent folding properties not only at a low temperature of −30° C. and a high temperature of 60° C., but also in a harsh environment with a high temperature of 60° C. and a relative humidity of 90% or more.

### <Display>

The present disclosure also provides a display including the adhesive sheet described above. The display of the present disclosure may include a configuration commonly known in the art, as long as it includes the adhesive composition and/or adhesive sheet of the present disclosure.

When the adhesive sheet satisfying the above elastic modulus is used in a foldable and/or flexible display, problems such as breakage, lifting, peeling, and formation of wrinkles (stripes) of the adhesive sheet may be significantly overcome even when the adhesive sheet is exposed to continuous folding operation. In addition, the adhesive sheet may also have excellent adhesion to various types of substrates, which is preferable.

Hereinafter, specific examples for carrying out the present disclosure will be described, but the present disclosure is not limited to the following contents and may be appropriately modified to the extent necessary in the art.

### Production Examples: Acrylic Copolymers

### Production Example 1

70 wt % of 2-ethylhexyl acrylate (2-EHA), 20 wt % of 2-decyl-1-tetradekenyl acrylate (DTD-A), 0.2 wt % of acrylic acid (AA), and 9.8 wt % of 4-hydroxybutyl acrylate (4-HBA) were added to a 1-L reactor equipped with a nitrogen gas inlet and a reflux condenser for easy temperature control, and then 100 parts by weight of ethyl acetate (EA) as a solvent was added thereto. Thereafter, nitrogen gas as a replacement gas was introduced for 1 hour to remove oxygen and then the temperature was maintained at 62° C. After the mixture was stirred uniformly, 0.07 parts by weight of azobisisobutyronitrile (AIBN) as a reaction initiator was added thereto, followed by reaction for 8 hours, thereby producing acrylic copolymer A-1 having a weight-average molecular weight of 1.13 million or more.

### Production Examples 2 to 4

Acrylic copolymers A-2 to A-4 were produced in the same manner as in Production Example 1, except that the composition shown in Table 1 below was used.

TABLE 1

| | Monomer | | | | | | | | Hydroxyl | | |
|---|---|---|---|---|---|---|---|---|---|---|---|
| | having 1 to 7 | | Linear or branched monomer | | | | | | group-containing | | Molecular weight |
| | carbon atoms | | having 8 to 30 carbon atoms | | | | Polar monomer | | monomer | | MW (ten |
| | MA | BA | 2-EHA | LA | SA | DTD-A | AA | 2-CEA | 4-HBA | 6-HHA | thousand) |
| Production | | | 70 | | | 20 | 0.2 | | 9.8 | | 105 |
| Example 1 | | | | | | | | | | | |
| (A-1) | | | | | | | | | | | |
| Production | | | 70 | | 15 | | 0.1 | | 9.9 | 5 | 112 |
| Example 2 | | | | | | | | | | | |
| (A-2) | | | | | | | | | | | |
| Production | | | 69.5 | 10 | | 10 | | 0.5 | 10 | | 107 |
| Example 3 | | | | | | | | | | | |
| (A-3) | | | | | | | | | | | |
| Production | 15 | 75 | | | | | 0.2 | | 9.8 | | 105 |
| Example 4 | | | | | | | | | | | |
| (A-4) | | | | | | | | | | | |

MA: methyl acrylate, TCI
BA: butyl acrylate, TCI
EHA: 2-ethylhexyl acrylate, Sigma-Aldrich
LA: lauryl acrylate, Kyoeisha Chemical
SA: stearyl acrylate, Kyoeisha Chemical
DTD-A: 2-decyl-1-tetradecanyl acrylate, Kyoeisha Chemical
AA: acrylic acid, Sigma-Aldrich
2-CEA: 2-carboxyethyl acrylate, Sigma-Aldrich
4-HBA: 4-hydroxybutylacrylate, Sigma-Aldrich
6-HHA: 6-hydroxyhexyl acrylate, Hanin Precision

### Synthesis Example: Synthesis of UV Absorber

### Synthesis Example 1

In a reactor, a mixture of 2,4,6-trichloro-1,3,5-triazine (18.4 g, 0.1 mol), 2-methylresorcinol (43.4 g, 0.35 mol), and aluminum chloride (20 g, 0.15 mol) is dissolved in chlorobenzene and cyclopentyl methyl ether, and is stirred and reacted for 2 hours. After completion of the reaction, 6N of hydrochloric acid was added at 80° C., and followed by stirring for 1 hour at 90° C.

Thereafter, 200 g of toluene was added and reflux dehydrated for 2 hours, and the mixture was filtered to obtain 2,4,6-tris(2,4-dihydroxy-3-methylphenyl)-1,3,5-triazine.

2,4,6-tris (2,4-dihydroxy-3-methylphenyl)-1,3,5-triazine (5 g, 11.2 mmol) obtained above and N,N-dimethylformamide are put into a reactor, dissolved, and potassium carbonate (5.4 g, 39.2 mmol) is added thereto. Then, 2-ethylhexyl bromide (3.2 g, 16.8 mmol) was slowly added thereto, and the mixture was allowed to react with stirring for 6 hours or more at a temperature of 80° C. under a nitrogen atmosphere.

After the reaction is completed, the mixture is cooled to room temperature, distilled water is added to stop the reaction, and the mixture was extracted with ethyl acetate (×3), and a compound represented by Formula 1-1 is obtained by using a silica column.

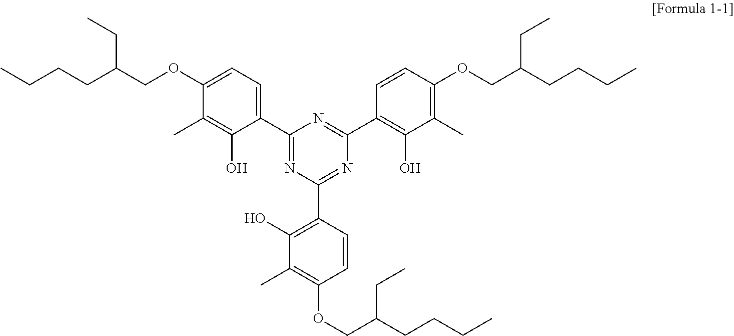 [SMILES: CCCCC(CC)COc1ccc(-c2nc(-c3ccc(OCC(CC)CCCC)c(C)c3O)nc(-c3ccc(OCC(CC)CCCC)c(C)c3O)n2)c(O)c1C]

### Synthesis Example 2

In a reactor, a mixture of 2,4,6-trichloro-1,3,5-triazine (18.4 g, 0.1 mol), 2-methylresorcinol (43.4 g, 0.35 mol), and aluminum chloride (20 g, 0.15 mol) is dissolved in chlorobenzene and cyclopentyl methyl ether, and is stirred and reacted for 2 hours. After completion of the reaction, 6N of hydrochloric acid was added at 80° C., and followed by stirring for 1 hour at 90° C.

Thereafter, 200 g of toluene was added and reflux dehydrated for 2 hours, and the mixture was filtered to obtain 2,4,6-tris (2,4-dihydroxy-3-methylphenyl)-1,3,5-triazine.

2,4,6-tris (2,4-dihydroxy-3-methylphenyl)-1,3,5-triazine (5 g, 11.2 mmol) obtained above and N,N-dimethylformamide are put into a reactor, dissolved, and potassium carbonate (5.4 g, 39.2 mmol) is added thereto. Then, octyl bromide (3.2 g, 16.8 mmol) was slowly added thereto, and the mixture was allowed to react with stirring for 6 hours or more at a temperature of 80° C. under a nitrogen atmosphere.

After the reaction is completed, the mixture is cooled to room temperature, distilled water is added to stop the reaction, and the mixture was extracted with ethyl acetate (×3), and a compound represented by Formula 1-2 is obtained by using a silica column.

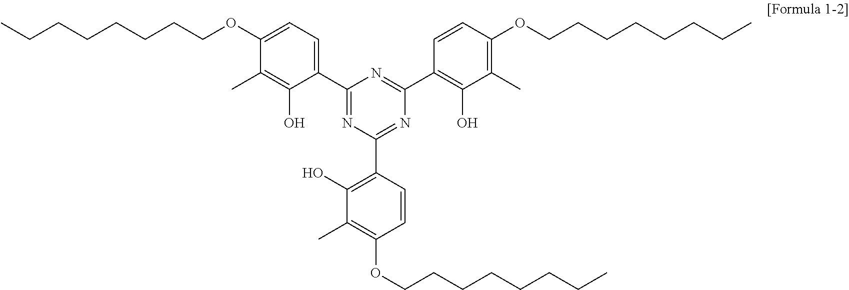 [SMILES: CCCCCCCCOc1ccc(-c2nc(-c3ccc(OCCCCCCCC)c(C)c3O)nc(-c3ccc(OCCCCCCCC)c(C)c3O)n2)c(O)c1C]

In a reactor, 2,4,6-tris(2,4-hydroxyphenyl)-1,3,5-triazine (5 g, 12.3 mmol) was dissolved in N,N-dimethylformamide, and then potassium carbonate (6 g, 43.1 mmol) was added to the solution. Thereafter, 2-ethylhexyl bromide (3.6 g, 18.5 mmol) was slowly added thereto, and the mixture was allowed to react with stirring for 6 hours or more at a temperature of 80° C. under a nitrogen atmosphere. After completion of the reaction, the mixture was cooled to room temperature, and distilled water was added to stop the reaction. Then, the mixture was extracted with ethyl acetate (×3) and purified using a silica column to obtain a compound represented by Formula 2-1.

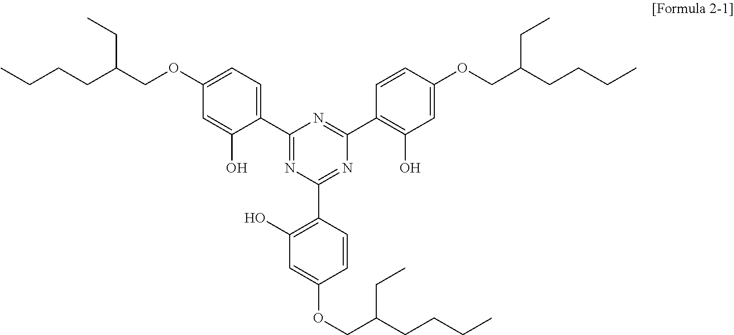 [SMILES: CCCCC(CC)COc1ccc(-c2nc(-c3ccc(OCC(CC)CCCC)cc3O)nc(-c3ccc(OCC(CC)CCCC)cc3O)n2)c(O)c1]

### Examples and Comparative Examples: Preparation of Adhesive Compositions and Adhesive Sheets

### (1) Adhesive Composition

The components shown in Table 2 below were mixed together in the contents shown in Table 2 below, and the mixture was diluted in an organic solvent in consideration of the coating properties, thereby preparing an adhesive composition. Here, the contents are parts by weight.

### (2) Adhesive Sheet

The prepared adhesive composition was applied to a film coated with a silicone release agent so that the thickness after drying was 50 μm. Then, the applied adhesive composition was dried at 100° C. for 5 minutes, and then laminated with a release film to form an adhesive sheet.

TABLE 2

| | Copolymer | | Crosslinking agent | | | | Silane coupling agent | | UV absorber | | Plasticizer | |
|---|---|---|---|---|---|---|---|---|---|---|---|---|
| | Type | Content | Type | Content | Type | Content | Type | Content | Type | Content | Type | Content |
| Example 1 | A-1 | 100 | B-1 | 0.4 | B-4 | 0.1 | C | 0.5 | D-1 | 1.5 | E | 5 |
| Example 2 | A-1 | 100 | B-1 | 0.3 | B-5 | 0.2 | C | 0.5 | D-1 | 1.5 | E | 5 |
| Example 3 | A-1 | 100 | B-2 | 0.5 | | | C | 0.5 | D-1 | 1.5 | E | 5 |
| Example 4 | A-1 | 100 | B-3 | 1 | | | C | 0.5 | D-1 | 1.5 | E | 5 |
| Example 5 | A-2 | 100 | B-2 | 0.3 | B-4 | 0.2 | C | 0.5 | D-1 | 1.5 | E | 5 |
| Example 6 | A-3 | 100 | B-2 | 0.5 | B-5 | 0.05 | C | 0.5 | D-1 | 1.5 | E | 5 |
| Example 7 | A-2 | 100 | B-3 | 0.7 | B-4 | 0.05 | C | 0.5 | D-1 | 1.5 | E | 5 |
| Example 8 | A-3 | 100 | B-3 | 1 | | | C | 0.5 | D-1 | 1.5 | E | 5 |
| Example 9 | A-1 | 100 | B-1 | 0.3 | B-5 | 0.2 | C | 0.5 | D-2 | 1.5 | E | 5 |
| Example 10 | A-1 | 100 | B-1 | 0.4 | B-4 | 0.1 | C | 0.5 | D-5 | 2 | E | 5 |
| Example 11 | A-1 | 100 | B-1 | 0.3 | B-5 | 0.2 | C | 0.5 | D-5 | 2 | E | 5 |
| Example 12 | A-1 | 100 | B-2 | 0.5 | | | C | 0.5 | D-5 | 2 | E | 5 |
| Example 13 | A-1 | 100 | B-3 | 1 | | | C | 0.5 | D-5 | 2 | E | 5 |
| Example 14 | A-2 | 100 | B-2 | 0.3 | B-4 | 0.2 | C | 0.5 | D-5 | 2 | F | 5 |
| Example 15 | A-3 | 100 | B-2 | 0.5 | B-5 | 0.05 | C | 0.5 | D-5 | 2 | E | 5 |
| Example 16 | A-2 | 100 | B-3 | 0.7 | B-4 | 0.05 | C | 0.5 | D-5 | 2 | E | 5 |
| Example 17 | A-3 | 100 | B-3 | 1 | | | C | 0.5 | D-5 | 2 | E | 5 |
| Comparative | A-1 | 100 | B-2 | 0.5 | | | C | 0.5 | D-3 | 1.5 | E | 5 |
| Example 1 | | | | | | | | | | | | |
| Comparative | A-1 | 100 | B-2 | 0.5 | | | C | 0.5 | D-4 | 1.5 | E | 5 |
| Example 2 | | | | | | | | | | | | |
| Comparative | A-1 | 100 | B-4 | 0.5 | | | C | 0.5 | D-3 | 1.5 | E | 5 |
| Example 3 | | | | | | | | | | | | |
| Reference | A-4 | 100 | B-2 | 0.5 | | | C | 0.5 | D-1 | 1.5 | E | 5 |
| Example 1 | | | | | | | | | | | | |
| Reference | A-1 | 100 | B-4 | 0.5 | | | C | 0.5 | D-1 | 1.5 | E | 5 |
| Example 2 | | | | | | | | | | | | |

B-1: Aluminum tris(acetylacetonate)
B-2: Diisopropoxyaluminum monooleyl acetoacetate
B-3: Zirconium tetrakis(acetylacetonate)
B-4: D-103: Isocyanate-based, Mitsui Chemicals
B-5: CL-467: Aziridine-based, Menadiona
C: KBM-403: 3-glycidoxypropyl trimethoxysilane, Shin-Etsu
D-1: Formula 1-1
D-2: Formula 1-2
D-3: CS-400, Songwon Industrial
D-4: LA-F70, Adeca
D-5: Formula 2-1
E: DOA, Aekyung Chemical

### Experimental Example

The physical properties of the adhesive sheets manufactured in Examples 1 to 17, Comparative Examples 1 to 3, and Reference Examples 1 to 2 were measured by the following methods, and the results are shown in Table 3 below.

### (1) Transmittance

The manufactured adhesive sheet was cut to a size of 50 mm×50 mm, the release film was peeled off, and the adhesive sheet was bonded to Corning glass. The release film on the opposite side of the adhesive sheet was peeled off, and the adhesive sheet was bonded to 0.1t soda glass, and then autoclaved, thereby preparing a specimen. The prepared specimen was measured for transmittance spectrum in the wavelength range of 300 to 800 nm using a spectrophotometer (UV-2450, Shimadzu).

### (2) Elastic Modulus

The storage elastic modulus was measured for each adhesive sheet before the optical member layer was laminated in the Examples, Comparative Examples, and Reference Examples.

For each adhesive sheet, the storage modulus was measured using a rheometer (MCR-301, Anton Paar). More specifically, the adhesive sheet was cut to a size of 30 mm in length×30 mm in width, the release film attached to one side of the cut adhesive sheet was removed, and then the cut adhesive sheet was bonded to a glass substrate. Thereafter, the resulting sheet was bonded to a measuring tip, and in this state, measurements were made under the conditions of a frequency of 1.0 Hz, a strain of 2%, and a heating rate of 5° C./min in a temperature range of −30 to 100° C. At this time, the measurement value at 25° C. was read, and the measurement results are shown in Table 3 below.

### (3) Adhesive Strength

After the release surface of the adhesive sheet of each of the Examples, Comparative Examples, and Reference Examples was peeled off, the adhesive sheet was bonded to a 50-μm PET film that had been corona- or plasma-treated, and then cut to a size of 25 mm×100 mm. The release film of the cut adhesive sheet was peeled off, and the adhesive surface was corona- or plasma-treated. Then, the adhesive sheet was laminated on a glass substrate and autoclaved, thereby preparing a specimen. The adhesive strength at room temperature was measured by leaving the prepared specimens under the conditions of 23° C. and 50% RH for 24 hours, and then peeling the adhesive layer using a universal tensile tester (UTM, Instron) at a peel speed of 300 mm/min and a peel angle of 180°. At this time, the measurement was performed under the conditions of 23° C. and 50% RH.

### (4) Foldability

The adhesive film manufactured in each of the Examples, Comparative Examples, and Reference Examples was bonded to 50-μm PET and cut to a size of 20 mm×100 mm, thereby preparing a specimen.

The specimen was fixed to a flexibility evaluation device (CFT-720C, COVOTECH) for folding evaluation, and folded with a radius of curvature of 2 mm, and folded 25 times per minute. Folding evaluation was performed under the conditions of −20° C., 60° C. and 90% RH with a 0.2-second holding time after one folding. In the folding evaluation, one folding was considered one cycle. If stripes, etc. appeared at the folding area after 30,000 folding cycles or if breakage, lifting or peeling of the adhesive film occurred, it was rated as X, if breakage, lifting or peeling of 0.3 mm or less occurred, it was rated as ∘, and if there were no problems at all, it was rated as ⊚.
⊚: No defects occurred after 50.000 or more folding cycles
∘: Defects occurred between 20,000 folding cycles and less than 50,000 folding cycles
x: Defects occurred within less than 20.000 folding cycles

TABLE 3

| | Transmit- | −20° C. | | Foldability | |
|---|---|---|---|---|---|
| | tance | elastic | Adhesive | | 60° C. |
| | [%] | modulus | strength | | and |
| | 380 nm | [kPa] | [N/25 mm] | −20° C. | 90% RH |
| Example 1 | 0.2 | 53 | 25 | ∘ | ⊚ |
| Example 2 | 0.3 | 55 | 27 | ∘ | ⊚ |
| Example 3 | 0.3 | 52 | 31 | ⊚ | ∘ |
| Example 4 | 0.3 | 54 | 29 | ⊚ | ⊚ |
| Example 5 | 0.4 | 52 | 25 | ∘ | ⊚ |
| Example 6 | 0.3 | 52 | 26 | ∘ | ∘ |
| Example 7 | 0.4 | 53 | 22 | ⊚ | ⊚ |
| Example 8 | 0.2 | 52 | 28 | ⊚ | ⊚ |
| Example 9 | 0.3 | 52 | 24 | ⊚ | ∘ |
| Example 10 | 0.2 | 52 | 26 | ∘ | ⊚ |
| Example 11 | 0.2 | 54 | 25 | ⊚ | ∘ |
| Example 12 | 0.3 | 52 | 29 | ∘ | ∘ |
| Example 13 | 0.3 | 53 | 30 | ⊚ | ⊚ |
| Example 14 | 0.2 | 53 | 26 | ⊚ | ⊚ |
| Example 15 | 0.3 | 54 | 24 | ∘ | ∘ |
| Example 16 | 0.2 | 54 | 25 | ⊚ | ⊚ |
| Example 17 | 0.3 | 52 | 27 | ⊚ | ⊚ |
| Comparative | 74.4 | 56 | 21 | ∘ | ∘ |
| Example 1 | | | | | |
| Comparative | Not measurable (precipitated) | | | x | x |
| Example 2 | | | | | |
| Comparative | 0.4 | 56 | 12 | x | ∘ |
| Example 3 | | | | | |
| Reference | 0.3 | 149 | 22 | X | X |
| Example 1 | | | | | |
| Reference | 0.5 | 52 | 14 | x | ∘ |
| Example 2 | | | | | |

Referring to the above experimental results, it can be confirmed that Examples 1 to 17, which include a UV absorber including at least one selected from the group consisting of the compounds represented by Formula 1 and Formula 2 according to the present disclosure, and Reference Examples 1 to 2, have low light transmittance at a 5 wavelength of 380 nm and thus have excellent ability to prevent UV-induced deterioration. In particular, it can be confirmed that Examples 1 to 17, which include an acrylic copolymer including the linear or branched alkyl (meth)acrylate monomer having 8 to 30 carbon atoms and the UV absorber including the compound represented by Formula 1, have excellent folding properties by having high adhesive strength while having low elastic modulus at low temperatures.

What is claimed is:

1. An adhesive composition comprising an acrylic copolymer, a crosslinking agent, an additive, and an UV absorber,
wherein the UV absorber comprises at least one selected from the group consisting of a compound represented by Formula 1 below and a compound represented by Formula 2 below: 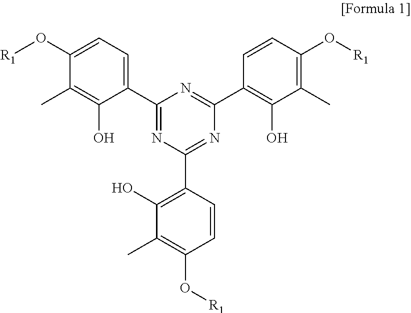
wherein R₁s are each independently a linear or branched alkyl group having 8 or more carbon atoms; 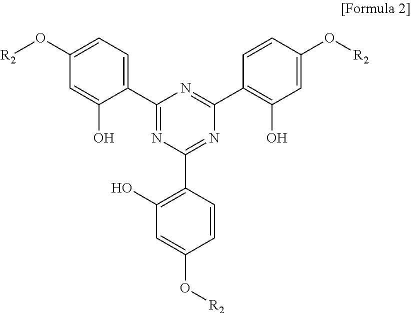
wherein R₂s are each independently a linear or branched alkyl group having 8 or more carbon atoms.

2. The adhesive composition of claim 1, wherein R₁s are each independently a linear or branched alkyl group having 8 to 24 carbon atoms, and R₂s are each independently a linear or branched alkyl group having 8 to 24 carbon atoms.

3. The adhesive composition of claim 1, wherein the UV absorber is comprised in an amount of 0.1 to 5 parts by weight based on 100 parts by weight of the acrylic copolymer.

4. The adhesive composition of claim 1, wherein the acrylic copolymer comprises a linear or branched alkyl (meth)acrylate monomer having 8 to 30 carbon atoms.

5. The adhesive composition of claim 4, wherein the acrylic copolymer further comprises a polar group-containing (meth)acrylate monomer and a hydroxyl group-containing (meth)acrylate monomer.

6. The adhesive composition of claim 1, wherein the crosslinking agent comprises a metal chelate-based crosslinking agent.

7. The adhesive composition of claim 6, wherein the crosslinking agent comprises one selected from the group consisting of zirconium, aluminum, zinc, and magnesium.

8. The adhesive composition of claim 6, wherein the crosslinking agent further comprises at least one selected from the group consisting of isocyanate-based, aziridine-based, epoxy-based, melamine-based, peroxide-based, and oxazoline-based crosslinking agents.

9. The adhesive composition of claim 1, wherein the additive further comprises at least one selected from the group consisting of a silane coupling agent, an antistatic agent, an antioxidant, an anti-corrosion agent, a leveling agent, a surface lubricant, an antifoaming agent, a filler, a plasticizer, and a reaction initiator.

10. The adhesive composition of claim 1, wherein an adhesive sheet formed from the adhesive composition has a light transmittance of 10% or less at a wavelength of 380 nm.

11. The adhesive composition of claim 1, wherein an adhesive sheet formed from the adhesive composition has an elastic modulus of 40 kPa to 100 kPa at −20° C. and 1 Hz.

12. An adhesive sheet comprising the adhesive composition according to claim 1.

13. A display comprising the adhesive sheet of claim 12.
